(19) United States
(12) Patent Application Publication
(10) Pub. No.: US 2023/0030245 A1
(43) Pub. Date: Feb. 2, 2023

(54) SYSTEMS AND METHODS FOR GENERATING LOCATION-BASED INFORMATION

(71) Applicant: HERE GLOBAL B.V., Eindhoven (NL)

(72) Inventors: JEROME BEAUREPAIRE, BERLIN (DE); LEON STENNETH, CHICAGO, IL (US); JEREMY MICHAEL YOUNG, CHICAGO, IL (US)

(21) Appl. No.: 17/390,593

(22) Filed: Jul. 30, 2021

(51) Int. Cl. G06Q 30/02; G06F 40/30; G06F 16/951; G06F 16/9537; G06F 16/9538

(52) U.S. Cl. CPC G06Q 30/0282; G06F 40/30; G06F 16/951; G06F 16/9537; G06F 16/9538

(57) ABSTRACT

Systems and methods for generating location-based information are provided. For example, an apparatus for generating location-based information includes a processor and a memory. The memory includes computer program code. The computer program code is configured to cause the processor of the apparatus to determine review information based on a user review. The computer program code is further configured to cause the processor of the apparatus to determine a location associated with the review information. The computer program code is further configured to cause the processor of the apparatus to analyze traffic data based on the location. The computer program code is further configured to cause the processor of the apparatus to, based on the analysis, provide data for modifying the user review.

### TECHNICAL FIELD

The present disclosure relates generally to user reviews, products and services, and more specifically to systems and methods for generating location-based information.

### BACKGROUND

User reviews are an invaluable asset to any business which interacts with individuals via the Internet. More recently, online reviews have become an industry unto themselves, with many third-party customer review companies being created where individuals can post reviews of their experiences. Despite the potential benefits, some user reviews, especially online reviews, may not include all the information that is needed for an individual to make an informed decision.

### BRIEF SUMMARY

The present disclosure overcomes the shortcomings of prior technologies. In particular, a novel approach for generating location-based information is provided, as detailed below.

In accordance with an aspect of the disclosure, an apparatus for generating location-based information is provided. The apparatus includes a processor. The apparatus also includes a memory comprising computer program code for one or more programs. The memory and the computer program code are configured to cause the processor of the apparatus to determine review information based on a user review. The computer program code is further configured to cause the processor of the apparatus to determine a location associated with the review information. The computer program code is further configured to cause the processor of the apparatus to analyze traffic data based on the location. The computer program code is further configured to cause the processor of the apparatus to based on the analysis, provide data for modifying the user review.

In accordance with another aspect of the disclosure, a method for generating location-based information is provided. The method includes determining review information based on a user review. The method also includes determining a location corresponding to the review information. The method also includes analyzing route data based on the location. The method also includes based on the analysis, providing data for modifying the user review.

In accordance with another aspect of the present disclosure, a non-transitory computer-readable storage medium is provided. The non-transitory computer-readable storage medium includes one or more sequences of one or more instructions for execution by one or more processors of a device with a display screen and one or more input devices. The one or more instructions which, when executed by the one or more processors, cause the device to determine a location that corresponds to the user review. The one or more instructions further cause the device to analyze traffic data, route data, or weather data, or a combination thereof, that corresponds to the location. The one or more instructions further cause the device to based on the analysis, provide for display, via the display screen, a visual effect associated with the user review.

In addition, for various example embodiments, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment.

For various example embodiments, the following is also applicable: a method comprising facilitating access to at least one interface configured to allow access to at least one service, the at least one service configured to perform any one or any combination of network or service provider methods (or processes) disclosed in this application.

For various example embodiments, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment, and/or at least one signal resulting from one or any combination of methods (or processes) disclosed in this application as relevant to any embodiment.

For various example embodiments, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting, from one or any combination of methods (or processes) disclosed in this application as relevant to any embodiment, and/or at least one signal resulting from one or any combination of methods (or processes) disclosed in this application as relevant to any embodiment.

In various example embodiments, the methods (or processes) can be accomplished on the service provider side or on the mobile device side or in any shared way between service provider and mobile device with actions being performed on both sides.

For various example embodiments, the following is applicable. An apparatus comprising means for performing the method of the claims.

Still other aspects, features, and advantages are readily apparent from the following detailed description, simply by illustrating a number of particular embodiments and implementations. The drawings and description are to be regarded as illustrative in nature, and not as restrictive.

### BRIEF DESCRIPTION OF THE DRAWINGS

The embodiments are illustrated by way of example, and not by way of limitation, in the figures of the accompanying drawings:

FIG. 1 is a diagram of a system capable of providing location-based information, in accordance with aspects of the present disclosure;

FIG. 2A is a diagram illustrating a process for providing location-based information, in accordance with aspects of the present disclosure;

FIG. 2B is a diagram illustrating an example map for providing location-based information, in accordance with aspects of the present disclosure:

FIG. 3A is a diagram illustrating another example process for providing location-based information, in accordance with aspects of the present disclosure:

FIG. 3B is a diagram illustrating another example map for providing location-based information, in accordance with aspects of the present disclosure;

FIG. 4A is a diagram illustrating another example process for providing location-based information, in accordance with aspects of the present disclosure;

FIG. 4B is a diagram illustrating another example map for providing location-based information, in accordance with aspects of the present disclosure;

FIG. 5A is a diagram illustrating another example process for providing location-based information, in accordance with aspects of the present disclosure;

FIG. 5B is a diagram illustrating another example map for providing location-based information, in accordance with aspects of the present disclosure:

FIG. 6 is a diagram of a geographic database, in accordance with aspects of the present disclosure:

FIG. 7 is a diagram of the components of a data analysis system, in accordance with aspects of the present disclosure:

FIG. 8 is a flowchart setting forth steps of an example process, in accordance with aspects of the present disclosure;

FIG. 9 is a flowchart setting forth steps of another example process, in accordance with aspects of the present disclosure;

FIG. 10 is a flowchart setting forth steps of another example process, in accordance with aspects of the present disclosure,

FIG. 11 is a diagram of an example computer system, in accordance with aspects of the present disclosure:

FIG. 12 is a diagram of an example chip set, in accordance with aspects of the present disclosure; and

FIG. 13 is a diagram of an example mobile device, in accordance with aspects of the present disclosure.

### DESCRIPTION OF SOME EMBODIMENTS

Examples of a method, apparatus, and a non-transitory computer-readable storage medium for generating location-based information are disclosed. In the following description, for the purposes of explanation, numerous specific details are set forth in order to provide a thorough understanding of the embodiments. It is apparent, however, to one skilled in the art that the embodiments may be practiced without these specific details or with an equivalent arrangement. In other instances, well-known structures and devices are shown in block diagram form in order to avoid unnecessarily obscuring the embodiments.

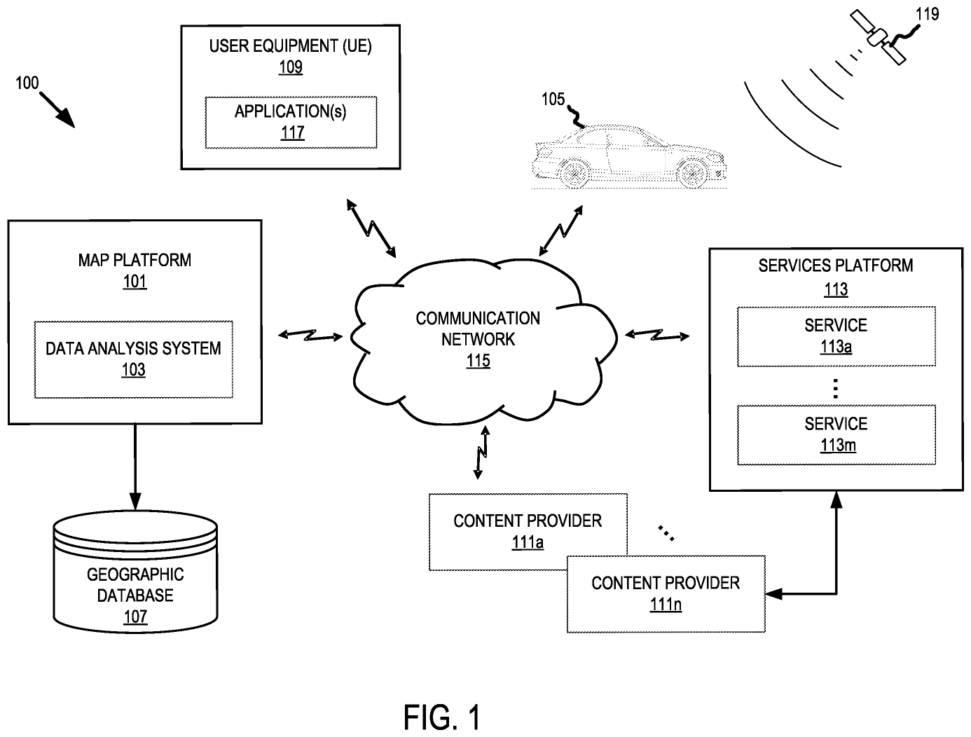

FIG. 1 is a diagram of a system 100 capable of generating location-based information, according to one embodiment. In one embodiment, the system 100 is configured to determine review information based on a user review. In one example, the review information is based on an individual's experience while visiting a particular location and submitted by the individual via an electronic device (e.g., smartphone, laptop, desktop, etc.). In one embodiment, the system 100 is configured to select one or more elements from the review information. In one example, the one or more elements refer directly or indirectly to a location. In another example, the one or more elements include a temporal element that describes how long it took for an individual to reach a destination. In another example, the one or more elements include a contextual element that describes the availability of parking nearby a location. In one embodiment, based on the selected element(s), the system 100 is configured to analyze traffic data, route data, or weather data, or a combination thereof, to determine location-based information that corresponds to the review information. Continuing with this example, the system 100 is configured to modify the user review based on the analysis. In one example, modifying the user review may include generating a hyperlink that provides additional information to the selected element(s). In another example, modifying the user review may include correcting the review information.

In one example, the system 100 of FIG. 1 determines the review information based on a user review that is viewable on a website. In one example, the review information may include electronic text that corresponds to a location. In one embodiment, the system 100 is configured to determine the location that corresponds to the review information. For example, the system 100 may determine a location for a place of business (e.g., a hotel) that is associated with the review information. In this example, the system 100 may analyze traffic data based on the determined location of the place of business. Continuing with this example, based on the analysis of the traffic data, the system 100 may provide data for modifying the user review. In one example, the system 100 may provide data for modifying the user review by generating a hyperlink that includes traffic information surrounding the place of business.

In another example, the system 100 may analyze route data based on the determined location from the review information. In this example, based on the analysis of the route data, the system 100 may provide data for modifying the user review by generating a map that includes one or more routes to a location associated with the review information. In another example, the system 100 may provide data for modifying the user review that includes updated information (e.g., a particular route is unavailable due to seasonal closures) corresponding to the location.

In another example, the system 100 may analyze weather data based on the determined location from the review information. In this example, based on the analysis of the weather data, the system 100 may provide data for modifying the user review by generating visual aspects that depict a weather forecast corresponding to a selected element of the review information. By way of example, the one or more visual aspects may be provided for display as an overlay of the user review.

In one embodiment, the system 100 is configured to analyze a combination of traffic data and route data. In this embodiment, the system 100 may provide data for modifying the user review by prioritizing a particular mode of transportation based on the analysis of the traffic data and the route data. In another embodiment, the system 100 is configured to analyze a combination of weather data and route data. In this embodiment, the system 100 may provide data for modifying the review information by excluding a particular mode of transportation based on the analysis of the weather data and the route data.

In another embodiment, the system 100 may provide data for modifying the user review as a way of improving the relevancy the review information. For example, the review information may indicate that a place of business was busy but not include the date or time of when the place of business was busy. In this example, the system 100 may provide data for modifying the review information with additional information (e.g., less than 10 minutes of wait time on Tuesday mornings) based on an analysis of traffic data surrounding the place of business at various dates and times.

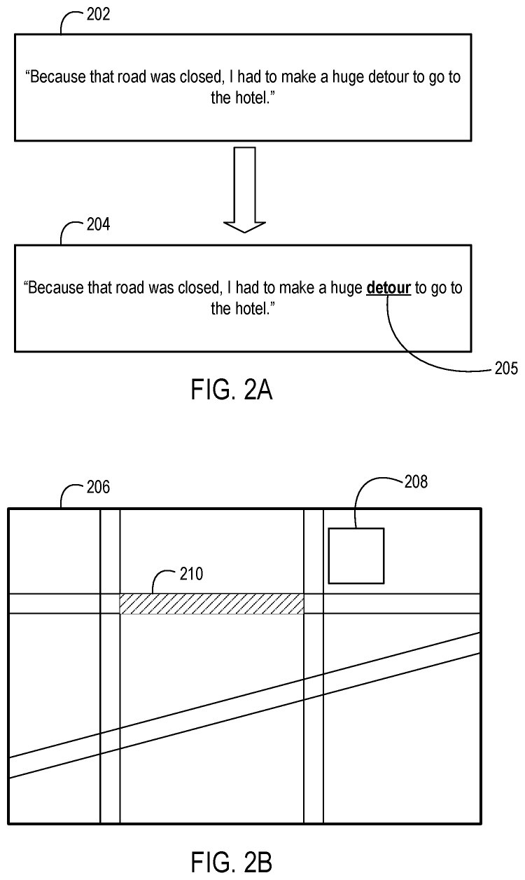

FIG. 2A is a diagram illustrating an example process for providing location-based information, according to one embodiment. FIG. 2B is a diagram illustrating an example map for providing location-based information, according to one embodiment. As shown, FIG. 2A includes a user review 202 and a modified user review 204. The modified user review 204 includes a hyperlink 205. As shown, FIG. 2B includes a digital map 206. The digital map 206 includes a location 208 and a road segment 210. The digital map 206 is viewable via the hyperlink 205.

In one embodiment, the system 100 of FIG. 1 is configured to determine the review information from the user review 202. As shown in FIG. 2A, the user review 202 describes a person's experience while traveling to a hotel. As shown in FIG. 2A, the review information indicates that “Because that road was closed, I had to make a huge detour to go to the hotel.” However, the review information does not mention what caused the detour. In one example, the system 100 is configured to determine the location 208 and analyze historical traffic data or historical weather data, or a combination thereof, based on the location 208. In this example, the system 100 is configured to determine that based on the time of visit to the hotel there was a detour due to a closure of the road segment 210. Continuing with this example, based on the analysis, the system 100 provides data for modifying the user review 202. As shown in FIG. 2A, the modification is a hyperlink 205 associated with the word ‘detour’ in the review information. The hyperlink associated with the word ‘detour’ enables access to the digital map 206. As shown in FIG. 2B, the road segment 210 is highlighted to bring attention to the determined detour from the user review 202. It is envisioned that the system 100 can be configured to search for geographic points (e.g., coordinates or other location points), map tiles, road links or segments, nodes, points of interests (POIs), and/or any other map feature or area represented in a geographic database when performing an analysis of traffic data, route data, or weather data, or a combination thereof.

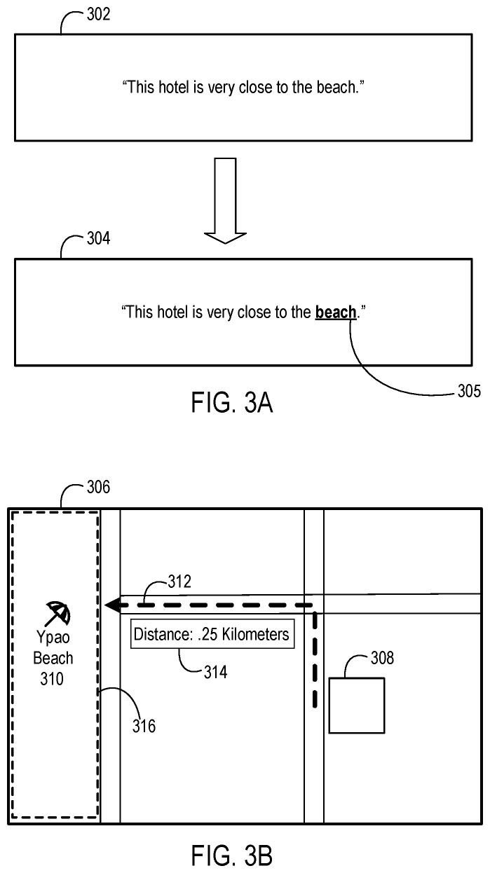

FIG. 3A is a diagram illustrating another example process for providing location-based information, according to one embodiment. FIG. 3B is a diagram illustrating another example map for providing location-based information, according to one embodiment. As shown, FIG. 3A includes a user review 302 and a modified user review 304. The modified user review 304 includes a hyperlink 305. As shown, FIG. 3B includes a digital map 306. The digital map 306 includes a location 308, a location 310, a route 312, route information 314, and an area 316. The digital map 306 is viewable via the hyperlink 305.

In one embodiment, the system 100 of FIG. 1 is configured to determine the review information from the user review 302. As shown in FIG. 3A, the user review 302 describes a person's experience regarding the proximity of a beach to a hotel. As shown in FIG. 3A, the review information indicates that “This hotel is very close to the beach.” However, the review information from the user review 302 does not mention which beach is close to the hotel. In one example, the system 100 is configured to determine the location 308 of the hotel and search the closest reachable beach based on the location 308 and route data. In this example, system 100 is configured to determine the location 310 associated with Ypao Beach. Continuing with this example, based on the analysis of the route data, the system 100 provides data for modifying the user review 302 that includes a hyperlink for accessing a digital map. As shown in FIG. 3A, the modification to the user review 302 is a hyperlink 305 associated with the word ‘beach’ in the user review 304. The hyperlink associated with the word ‘beach’ provides access to the digital map 306. As shown in FIG. 3B, the route 312 from the hotel i.e., the location 308) to Ypao Beach (i.e., the location 310) is included in the digital map 306. As shown in FIG. 3B, the route information 314 provides information about the distance to Ypao Beach from the hotel. Further, the area 316 is highlighted to bring attention to the determined beach from the user review 302.

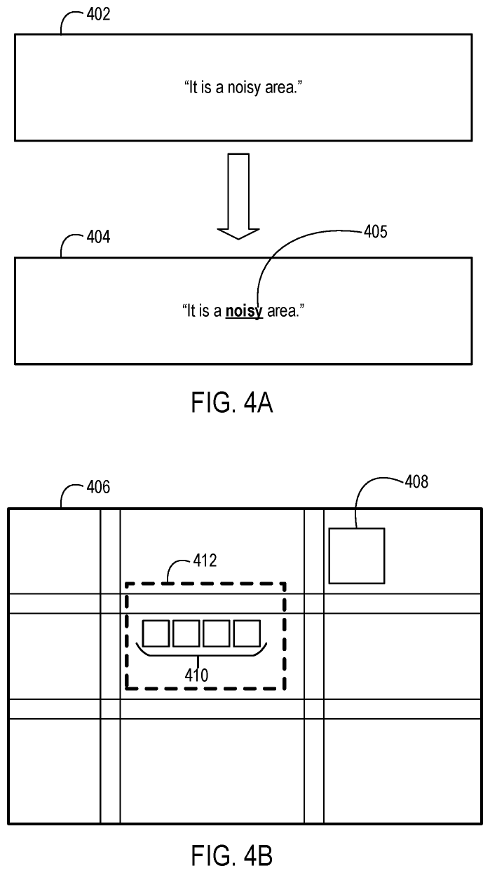

FIG. 4A is a diagram illustrating another example process for providing location-based information, according to one embodiment. FIG. 4B is a diagram illustrating another example map for providing location-based information, according to one embodiment. As shown, FIG. 4A includes a user review 402 and a modified user review 404. The modified user review 404 includes a hyperlink 405. As shown, FIG. 4B includes a digital map 406. The digital map 406 includes a location 408, business locations 410, and an area 412. The digital map 406 is viewable via the hyperlink 405.

In one embodiment, the system 100 of FIG. 1 is configured to determine the review information from the user review 402. As shown in FIG. 4A, the user review 402 describes a person's experience regarding a noisy area relative to a location. As shown in FIG. 4A, the review information indicates that “It is a noisy area.” However, the review information from the user review 402 does not include what area is noisy relative to the location. In one example, the system 100 is configured to determine the location 408 and search what areas surrounding the location 408 could be related to noise based on traffic data. Continuing with this example, based on the analysis of the traffic data, the system 100 provides data for modifying the user review 402 that includes a hyperlink for accessing a digital map. As shown in FIG. 4A, the modification to the user review 402 is a hyperlink 405 associated with the word ‘noisy’ in the user review 404. The hyperlink associated with the word ‘noisy’ provides access to the digital map 406. As shown in FIG. 4B, in one example, the system 100 is configured to determine that the business locations 410 are associated with higher traffic than other areas on the digital map 406. Continuing with this example, the system 100 is configured to display the area 412 that encompasses the business locations 410 as a way to provide location-based information associated with the user review 402.

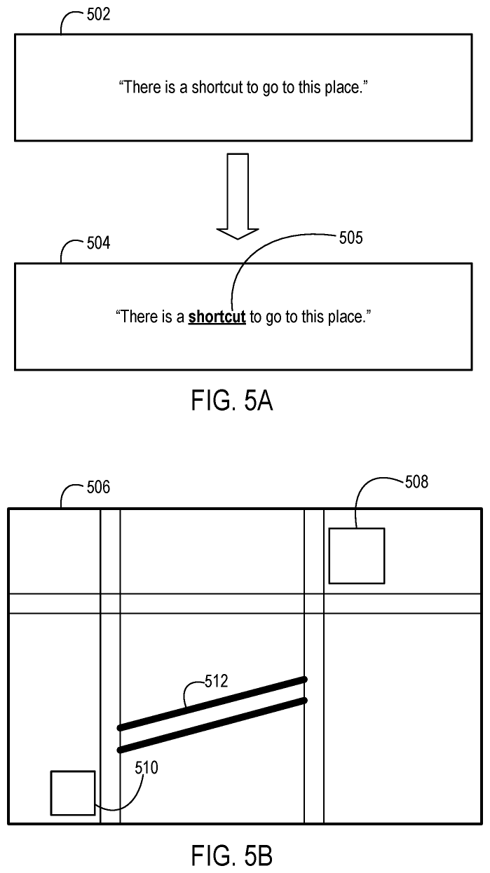

FIG. 5A is a diagram illustrating another example process for providing location-based information, according to one embodiment. FIG. 5B is a diagram illustrating another example map for providing location-based information, according to one embodiment. As shown, FIG. 5A includes a user review 502 and a modified user review 504. The modified user review 504 includes a hyperlink 505. As shown. FIG. 5B includes a digital map 506. The digital map 506 includes a location 508, a location 510, and a road segment 512. The digital map 506 is viewable via the hyperlink 505.

In one embodiment, the system 100 of FIG. 1 is configured to determine the review information from the user review 502. As shown in FIG. 5A, the user review 502 describes a person's experience regarding a shortcut to a destination. As shown in FIG. 5A, the review information indicates that “There is a shortcut to go to this place.” However, the review information from the user review 502 does not mention what road segment is the shortcut. In one example, the system 100 is configured to determine the location 508 and search road segments that reduce the time to travel to a location 510. In this example, the system 100 is configured to determine the road segment 512 reduces the time to travel from the location 508 to the location 510. Continuing with this example, based on the analysis of the route data, the system 100 provides data for modifying the user review 502 that includes a hyperlink for accessing a digital map. As shown in FIG. 5A, the modification to the user review 502 is a hyperlink 505 associated with the word ‘shortcut’ in the user review 504. The hyperlink associated with the word ‘shortcut’ provides access to the digital map 506. As shown in FIG. 5B, the road segment 512 is highlighted in order to bring attention to the shortcut mentioned in the user review 502.

Returning to FIG. 1, the map platform 101 can be a standalone server or a component of another device with connectivity to the communication network 115. For example, the component can be part of an edge computing network where remote computing devices (not shown) are installed along or within proximity of a given geographical area.

The communication network 115 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM, Internet protocol multimedia subsystem (IMS), universal mobile telecommunications system (UMTS), etc., as well as any other suitable wireless medium, e.g., worldwide interoperability for microwave access (WiMAX). Long Term Evolution (LTE) networks, fifth generation mobile (5G) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MAN ET), and the like, or any combination thereof.

In one embodiment, the map platform 101 may be a platform with multiple interconnected components. The map platform 101 may include multiple servers, intelligent networking devices, computing devices, components and corresponding software for generating location-based information or other map functions. In addition, it is noted that the map platform 101 may be a separate entity of the system 100, a part of one or more services 113a-113m of a services platform 113.

The services platform 113 may include any type of one or more services 113a-113m. By way of example, the one or more services 113a-113m may include weather services, mapping services, navigation services, travel planning services, notification services, social networking services, content (e.g., audio, video, images, etc.) provisioning services, application services, storage services, contextual information determination services, location-based services, news services, etc. In one embodiment, the services platform 113 may interact with the map platform 101, and/or one or more content providers 111a-111n to provide the one or more services 113a-113m.

In one embodiment, the one or more content providers 111a-111n in may provide content or data to the map platform 101, and/or the one or more services 113a-113m. The content provided may be any type of content, mapping content, textual content, audio content, video content, image content, etc. In one embodiment, the one or more content providers 111a-111n in may provide content that may aid in generating the location-based information according to the various embodiments described herein. In one embodiment, the one or more content providers 111a-111n may also store content associated with the map platform 101, and/or the one or more services 113a-113m. In another embodiment, the one or more content providers 111a-111n may manage access to a central repository of data, and offer a consistent, standard interface to data.

By way of example, the UE 109 may be, or include, an embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the UE 109 may support any type of interface with a user (e.g., by way of various buttons, touch screens, consoles, displays, speakers, “wearable” circuitry, and other I/O elements or devices). Although shown in FIG. 1 as being separate from the vehicle 105, in some embodiments, the UE 109 may be integrated into, or part of, the vehicle 105.

In one embodiment, the UE 109, may execute one or more applications 117 (e.g., software applications) configured to carry out steps in accordance with methods described here. For instance, in one non-limiting example, the application 117 may carry out steps for modifying a user review. In another non-limiting example, application 117 may also be any type of application that is executable on the UE 109 and/or vehicle 305, such as autonomous driving applications, mapping applications, location-based service applications, navigation applications, content provisioning services, camera/imaging application, media player applications, social networking applications, calendar applications, and the like. In yet another non-limiting example, the application 117 may act as a client for the data analysis system 103, and perform one or more functions associated with providing data for providing location-based information, either alone or in combination with the data analysis system 103.

In some embodiments, the UE 109 and/or the vehicle 105 may include various sensors for acquiring a variety of different data or information. For instance, the UE 109, and/or the vehicle 105 may include one or more camera/imaging devices for capturing imagery (e.g., terrestrial images), global positioning sensors (GPS) or Global Navigation Satellite System (GNSS) sensors for gathering location or coordinates data, network detection sensors for detecting wireless signals, receivers for carrying out different short-range communications (e.g., Bluetooth, Wi-Fi, Li-Fi, near field communication (NFC) etc.), temporal information sensors, Light Detection and Ranging (LIDAR) sensors, Radio Detection and Ranging (RADAR) sensors, audio recorders for gathering audio data, velocity sensors, switch sensors for determining whether one or more vehicle switches are engaged, and others.

The UE 109 and/or the vehicle 105 may also include light sensors, height sensors, accelerometers (e.g., for determining acceleration and vehicle orientation), tilt sensors (e.g., for detecting the degree of incline or decline), moisture sensors, pressure sensors, and so forth. Further, the UE 109 and/or the vehicle 105 may also include sensors for detecting the relative distance of the vehicle 105 from a lane or roadway, the presence of other vehicles, pedestrians, traffic lights, lane markings, speed limits, road dividers, potholes, and any other objects, or a combination thereof. Other sensors may also be configured to detect weather data, traffic information, or a combination thereof. Yet other sensors may also be configured to determine the status of various control elements of the car, such as activation of wipers, use of a brake pedal, use of an acceleration pedal, angle of the steering wheel, activation of hazard lights, activation of head lights, and so forth.

In some embodiments, the UE 109 and/or the vehicle 105 may include GPS, GNSS or other satellite-based receivers configured to obtain geographic coordinates from a satellite 119 for determining current location and time. Further, the location can be determined by visual odometry, triangulation systems such as A-GPS, Cell of Origin, or other location extrapolation technologies, and so forth. In some embodiments, two or more sensors or receivers may be co-located with other sensors on the IE 109 and/or the vehicle 105.

By way of example, the map platform 101, the services platform 113, and/or the one or more content providers 111a-111n communicate with each other and other components of the system 100 using well known, new or still developing protocols. In this context, a protocol includes a set of rules defining how the network nodes within the communication network 115 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically affected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

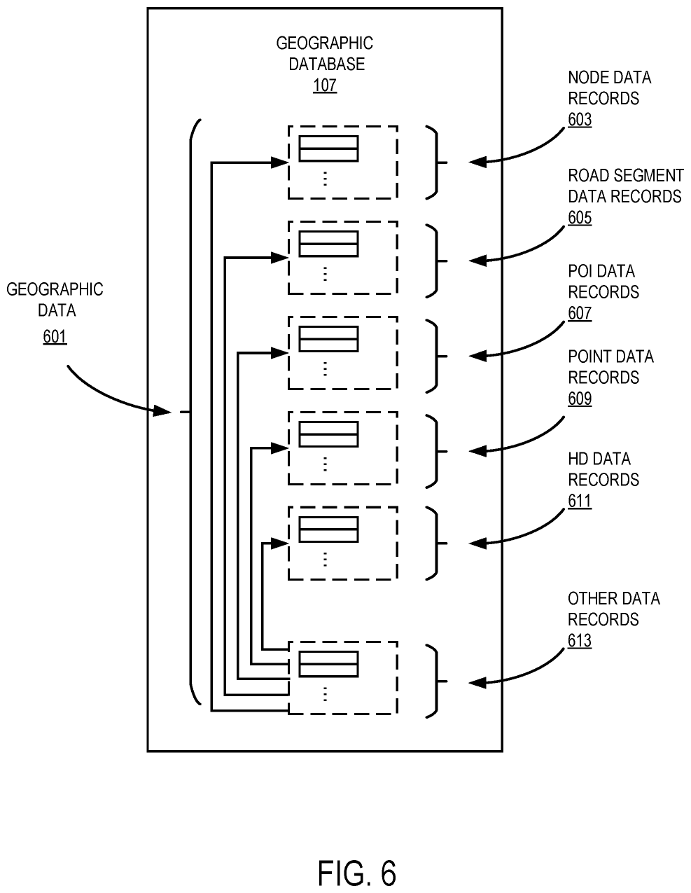

FIG. 6 is a diagram of the geographic database 107 of system 100, according to exemplary embodiments. In the exemplary embodiments, the data for modifying user reviews generated by the map platform 101 can be stored, associated with, and/or linked to the geographic database 107 or data thereof. In one embodiment, the geographic database 107 includes geographic data 601 used for (or configured to be compiled to be used for) mapping and/or navigation-related services, such as for personalized route determination, according to exemplary embodiments. For example, the geographic database 107 includes node data records 603, road segment data records 605, POI data records 607, point data records 609, HD data records 611, and other data records 613, for example. More, fewer or different data records can be provided. In one embodiment, the other data records 613 include cartographic (“carto”) data records, routing data, weather data, and maneuver data. In one example, the other data records 613 include historical review information or data that is associated with certain POIs, roads, or geographic areas. In one example, the historical review information or data is stored for utilization by a third-party. In one embodiment, the other data records include weather data records such as weather data reports. For example, the weather data records can be associated with any of the map features stored in the geographic database 107 (e.g., a specific road or link, node, intersection, area, POI, etc.) on which the weather data was collected. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using the point-based map matching embodiments describes herein), for example.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions, models, routes, etc. Accordingly, the terms polygons and polygon extrusions/models as used herein can be used interchangeably.

In one embodiment, the following terminology applies to the representation of geographic features in the geographic database 107.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 107 follows certain conventions. For example, links do not cross themselves and do not cross each other except at a node or vertex. Also, there are no duplicated shape points, nodes, or links. Two links that connect each other have a common node or vertex. In the geographic database 107, overlapping geographic features are represented by overlapping polygons. When polygons overlap, the boundary of one polygon crosses the boundary of the other polygon. In the geographic database 107, the location at which the boundary of one polygon intersects they boundary of another polygon is represented by a node. In one embodiment, a node may be used to represent other locations along the boundary of a polygon than a location at which the boundary of the polygon intersects the boundary of another polygon In one embodiment, a shape point is not used to represent a point at which the boundary of a polygon intersects the boundary of another polygon.

In one embodiment, the geographic database 107 is presented according to a hierarchical or multi-level tile projection. More specifically, in one embodiment, the geographic database 107 may be defined according to a normalized Mercator projection. Other projections may be used. In one embodiment, a map tile grid of a Mercator or similar projection can a multilevel grid. Each cell or tile in a level of the map tile grid is divisible into the same number of tiles of that same level of grid. In other words, the initial level of the map tile grid (e.g., a level at the lowest zoom level) is divisible into four cells or rectangles. Each of those cells are in turn divisible into four cells, and so on until the highest zoom level of the projection is reached.

In one embodiment, the map tile grid may be numbered in a systematic fashion to define a tile identifier (tile ID). For example, the top left tile may be numbered 00, the top right tile may be numbered 01, the bottom left tile may be numbered 10, and the bottom right tile may be numbered 11. In one embodiment, each cell is divided into four rectangles and numbered by concatenating the parent tile ID and the new tile position. A variety of numbering schemes also is possible. Any number of levels with increasingly smaller geographic areas may represent the map tile grid. Any level (n) of the map tile grid has 2(n+1) cells. Accordingly, any tile of the level (n) has a geographic area of A/2(n+1) where A is the total geographic area of the world or the total area of the map tile grids. Because of the numbering system, the exact position of any tile in any level of the map tile grid or projection may be uniquely determined from the tile ID.

In one embodiment, the system 100 may identify a tile by a quadkey determined based on the tile ID of a tile of the map tile grid. The quadkey, for example, is a one dimensional array including numerical values. In one embodiment, the quadkey may be calculated or determined by interleaving the bits of the row and column coordinates of a tile in the grid at a specific level. The interleaved bits may be converted to a predetermined base number (e.g., base 10, base 4, hexadecimal). In one example, leading zeroes are inserted or retained regardless of the level of the map tile grid in order to maintain a constant length for the one-dimensional array of the quadkey. In another example, the length of the one-dimensional array of the quadkey may indicate the corresponding level within the map tile grid. In one embodiment, the quadkey is an example of the hash or encoding scheme of the respective geographical coordinates of a geographical data point that can be used to identify a tile in which the geographical data point is located.

In exemplary embodiments, the road segment data records 605 are links or segments representing roads, streets, or paths, as can be used in the calculated route or recorded route information for determination of one or more personalized routes, according to exemplary embodiments. The node data records 603 are end points or vertices (such as intersections) corresponding to the respective links or segments of the road segment data records 605. The road segment data records 605 and the node data records 603 represent a road network, such as used by vehicles, cars, and/or other entities. Alternatively, the geographic database 107 can contain path segment and node data records or other data that represent pedestrian paths or areas in addition to or instead of the vehicle road record data, for example. In one embodiment, the road or path segments can include an altitude component to extend to paths or road into three-dimensional space (e.g., to cover changes in altitude and contours of different map features, and/or to cover paths traversing a three-dimensional airspace).

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 107 can include data about the POIs and their respective locations in the POI data records 607. The geographic database 107 can also include data about places, such as cities, towns, or other communities, and other geographic features, such as bodies of water, mountain ranges, etc. Such place or feature data can be part of the POI data records 607 or can be associated with POIs or POI data records 607 (such as a data point used for displaying or representing a position of a city).

As shown in FIG. 6, the geographic database 107 may also include point data records 609 for storing the point data, map features, as well as other related data used according to the various embodiments described herein. In addition, the point data records 609 can also store ground truth training and evaluation data, machine learning models, annotated observations, and/or any other data. By way of example, the point data records 609 can be associated with one or more of the node data records 603, road segment data records 605, and/or POI data records 607 to support verification, localization or visual odometry based on the features stored therein and the corresponding estimated quality of the features. In this way, the point data records 609 can also be associated with or used to classify the characteristics or metadata of the corresponding records 603, 605, and/or 607.

As discussed above, the HD data records 611 may include models of road surfaces and other map features to centimeter-level or better accuracy. The HD data records 611 may also include models that provide the precise lane geometry with lane boundaries, as well as rich attributes of the lane models. These rich attributes may include, but are not limited to, lane traversal information, lane types, lane marking types, lane level speed limit information, and/or the like. In one embodiment, the HD data records 611 may be divided into spatial partitions of varying sizes to provide HD mapping data to vehicles and other end user devices with near real-time speed without overloading the available resources of these vehicles and devices (e.g., computational, memory, bandwidth. etc. resources). In some implementations, the HD data records 611 may be created from high-resolution 3D mesh or point-cloud data generated, for instance, from LiDAR-equipped vehicles. The 3D mesh or point-cloud data may be processed to create 3D representations of a street or geographic environment at centimeter-level accuracy for storage in the HD data records 611.

In one embodiment, the HD data records 611 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

The geographic database 107 can be maintained by the one or more content providers 111a-111n in association with the services platform 113 (e.g., a map developer). The map developer can collect geographic data to generate and enhance the geographic database 107. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 107 can be a master geographic database stored in a format that facilitates updating, maintenance, and development. For example, the master geographic database 107 or data in the master geographic database 107 can be in an Oracle spatial format or other spatial format (for example, accommodating different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSE) format) to organize and/or configure the data for performing navigation-related functions and/or services, such as route calculation, route guidance, map display, speed calculation, distance and travel time functions, and other functions, by a navigation device. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

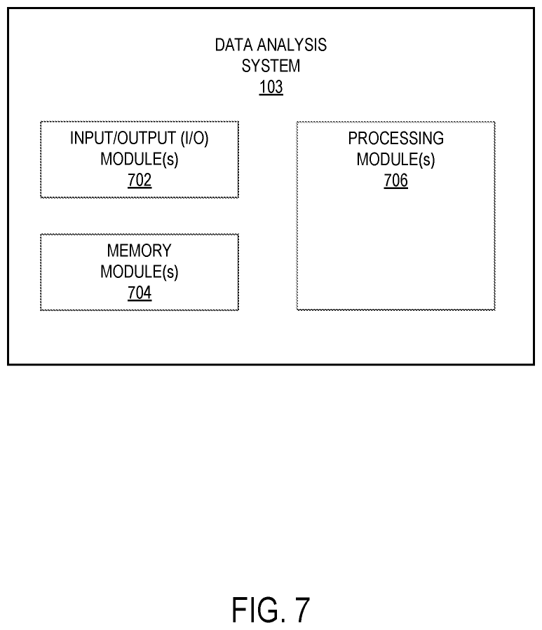

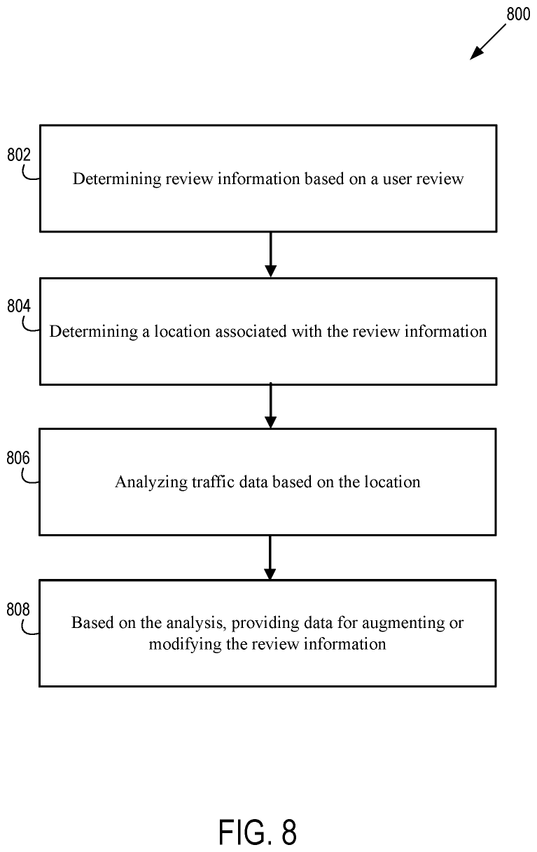

FIG. 7 is a diagram of the components of the data analysis system 103 of FIG. 1, according to one embodiment. By way of example, the data analysis system 103 includes one or more components for providing location-based information according to the various embodiments described herein. It is contemplated that the functions of these components may be combined or performed by other components of equivalent functionality. In this embodiment, data analysis system 103 includes in input/output module 702, a memory module 704, and a processing module 706. The above presented modules and components of the data analysis system 103 can be implemented in hardware, firmware, software, or a combination thereof. Though depicted as a separate entity in FIG. 1, it is contemplated that the data analysis system 103 may be implemented as a module of any of the components of the system 100 (e.g., a component of the services platform 113, etc.). In another embodiment, one or more of the modules 702-706 may be implemented as a cloud-based service, local service, native application, or combination thereof. The functions of these modules are discussed with respect to FIGS. 8, 9, and 10 below.

FIGS. 8, 9, and 10 are flowcharts of example methods, each in accordance with at least some of the embodiments described herein. Although the blocks in each figure are illustrated in a sequential order, the blocks may in some instances be performed in parallel, and/or in a different order than those described therein. Also, the various blocks may be combined into fewer blocks, divided into additional blocks, and/or removed based upon the desired implementation.

In addition, the flowcharts of FIGS. 8, 9, and 10 each show the functionality and operation of one possible implementation of the present embodiments. In this regard, each block may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include non-transitory computer-readable media that stores data for short periods of time, such as register memory, processor cache, or Random Access Memory (RAM), and/or persistent long term storage, such as read only memory (ROM), optical or magnetic disks, or compact-disc read only memory (CD-ROM), for example. The computer readable media may also be, or include, any other volatile or non-volatile storage systems. The computer readable medium may be considered a computer readable storage medium, a tangible storage device, or other article of manufacture, for example.

Alternatively, each block in FIGS. 8, 9, and 10 may represent circuitry that is wired to perform the specific logical functions in the process. Illustrative methods, such as those shown in FIGS. 8, 9, and 10, may be carried out in whole or in part by a component or components in the cloud and/or system. However, it should be understood that the example methods may instead be carried out by other entities or combinations of entities (i.e., by other computing devices and/or combinations of computing devices), without departing from the scope of the invention. For example, functions of the method of FIGS. 8, 9, and 10 may be fully performed by a computing device (or components of a computing device such as one or more processors), or may be distributed across multiple components of the computing device, across multiple computing devices, and/or across a server.

Referring first to FIG. 8, an example method 800 may include one or more operations, functions, or actions as illustrated by blocks 802-808. The blocks 802-808 may be repeated periodically or performed intermittently, or as prompted by a user, device or system. In one embodiment, the method 800 is implemented in whole or in part by the data analysis system 103 of FIG. 7.

As shown by block 802, the method 800 includes determining review information based on a user review. In one example, the input/output module 702 of FIG. 7 is configured to receive the user information. Continuing with this example, the processing module 706 of FIG. 7 is configured to receive the user review from the input/output module 702 and determine review information based on the user review. In one example, the processing module 706 is configured to perform a semantic analysis on the review information. In one example, the review information includes electronic text.

As shown by block 804, the method 800 also includes determining a location associated with the review information. In one example, the processing module 706 of FIG. 7 is configured to determine a location associated with the review information. In one example, the processing module 706 determines the location associated with the review information based on geographic data provided by memory module 704 of FIG. 7.

As shown by block 806, the method 800 also includes analyzing traffic data based on the location. In one example, the processing module 706 of FIG. 7 analyzes traffic data based on the location. In one example, the traffic data is stored in the memory module 704 of FIG. 7. In one example, the traffic data is historical traffic data corresponding to a temporal element of the review information. For example, the review information may refer to a place of business that is only open form 6 PM to 10 PM. In this example, the historical traffic data may be limited to traffic data during the hours of 6 PM to 10 PM. In another example, the traffic data is real-time traffic data.

As shown by block 808, the method 800 also includes based on the analysis, providing data for modifying the user review. In one example, the input/output module 702 of FIG. 7 is configured to provide data for modifying the user review based on the analysis. In one example the data for modifying the user review includes a hyperlink. In one example, the hyperlink may enable a pop-up window to display traffic data, route data, or weather data, or a combination thereof. In another example, the data for modifying the user review may include an instruction for applying a visual effect to the user review.

In one embodiment, the method 800 may further include determining a second location corresponding to the review information. In this embodiment, the method 800 may also include analyzing additional traffic data based on the location and the second location. In one example, the method 800 may further include providing data that includes recommended times of travel between the location and the second location.

In one embodiment, the method 800 may further include determining a score of the review information based on the analysis of the traffic data. In this embodiment, the method 800 may also include modifying the user review based on the determined score. In one example, a score may be determined by comparing one or more elements determined from the review information to historical traffic data. For example, the review information may indicate a travel time that an individual spent to reach a location. In this example, the travel time may be compared to historical traffic data for that particular day to determine whether to determine a positive or a negative score. Continuing with this example, if the score is positive, in other words if the review information is determined to be accurate, then an overlay of a visual effect such as the color green may be applied to the background of the user review. If the score is negative, in order words, if the review information is determined to be inaccurate, then an overlay of a visual effect such as the color red may be applied to the background of the user review. In this example, a user would be able to quickly see what reviews are more likely to be accurate based on the background colors of each review.

In one embodiment, the method 800 may further include determining a contextual element based on the review information. In this embodiment, the method 800 may also include analyzing the traffic data based on the location and the contextual element. In one example, the contextual element may be used to determine one or more lanes of a road that may be relevant regarding the traffic data. In another example, the contextual element may refer to a particular entrance at a building with multiple entrances. In this example, the traffic corresponding to the particular entrance may be analyzed.

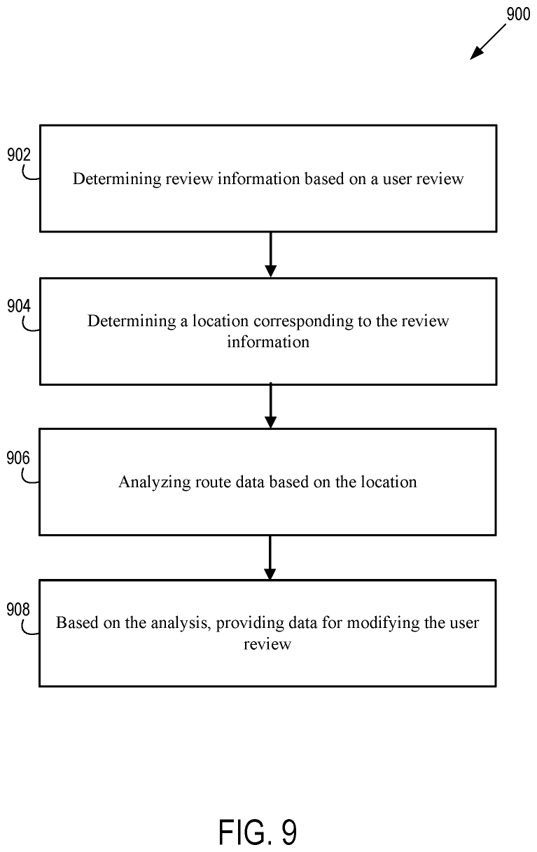

Referring to FIG. 9, the example method 900 may include one or more operations, functions, or actions as illustrated by blocks 902-908. The blocks 902-908 may be repeated periodically or performed intermittently, or as prompted by a user, device or system. In one embodiment, the method 900 is implemented in whole or in part by the data analysis system 103 of FIG. 7.

As shown by block 902, the method 900 includes determining review information based on a user review. Block 902 may be similar in functionality to block 802 of method 800.

As shown by block 904, the method 900 also includes determining a location corresponding to the review information. Block 904 may be similar in functionality to block 804 of method 800.

As shown by block 906, the method 900 also includes analyzing route data based on the location. In one example, the route data is historical route data corresponding to a temporal element of the review information. For example, the temporal element of the review information may correspond to a previous year that had route closures due to construction. Continuing with this example, the review information may be modified to explain why a particular route was unavailable based on the historical route data. In another example, the method 900 may further include analyzing route data based on the location and provide future information relevant to the location. For example, the method 900 may provide information that there will be similar construction starting three months from now. In this example, the upcoming similar construction may correspond to the temporal element of the review information. In another example, the method 900 can include predicting severe traffic or weather conditions that may have an impact in the future to the temporal element of the review information. In one example, the method 900 can include specific times or time frames related to the traffic or the weather conditions that may correspond to the temporal element of the review information. In one example, the processing module 706 of FIG. 7 is configured to analyze the route data based on the location.

As shown by block 908, the method 900 also includes based on the analysis, providing data for modifying the user review. Block 908 may be similar in functionality to block 808 of method 800.

In one embodiment, the method 900 may further include determining a second location corresponding to the review information. In this embodiment, the method 900 may also include determining one or more routes between the location and the second location based on the analysis of the route data. Continuing with this embodiment, the method 900 may also include providing information for the one or more routes. In one example, the one or more routes may include routes that are based on different modes of transportation. For example, a first route may correspond to an individual riding a train and a second route may correspond to an individual riding a bicycle.

In one embodiment, the method 900 may further include determining a score of the review information on the analysis of the route data. In this embodiment, the method 900 may also include modifying the user review based on the determined score. The score may be, but is not limited to, a numerical value (e.g., 1 through 10), a grade value (e.g., F through A, with F being the lowest grade and A being the highest grade), a categorical value (e.g., one of poor, moderate, and good), and so on. In one example, the score may be calculated based on a determined route according to an analysis of the review information and an optimal route determined from a geographical database. In one example, the score of a user review may be used as a weight for prioritizing the display of user reviews.

In one embodiment, the method 900 may further include determining a contextual element based on the review information. In this embodiment, the method 900 may also include analyzing the route data based on the location and the contextual element. In one example, the contextual element may be the cost of a ticket associated with a public transportation system. For example, the cost of the ticket may serve as a way of narrowing the one or more modes of transportation and thereby improving a determination of a route described indirectly within the review information.

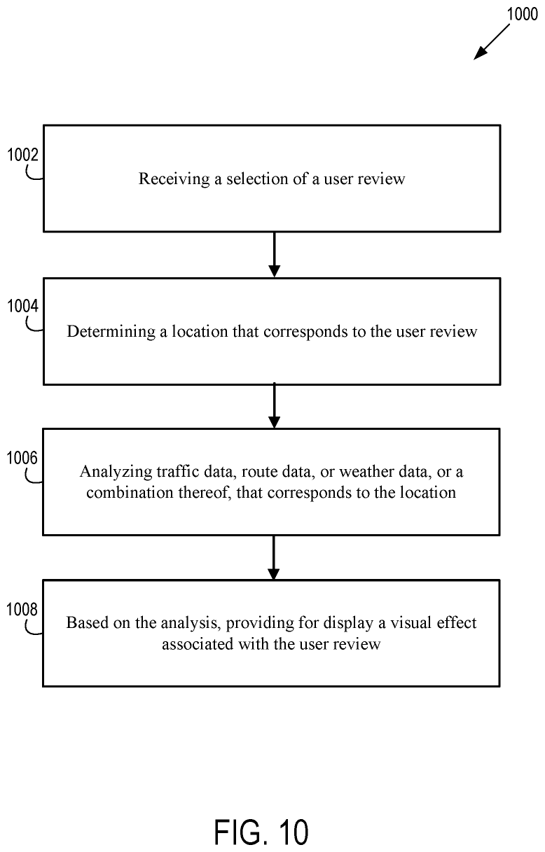

Referring to FIG. 10, the example method 1000 may include one or more operations, functions, or actions as illustrated by blocks 1002-1008. The blocks 1002-1008 may be repeated periodically or performed intermittently, or as prompted by a user, device or system. In one embodiment, the method 1000 is implemented in whole or in part by the data analysis system 103 of FIG. 7.

As shown by block 1002, the method 1000 includes receiving a selection of a user review. In one example, the input/output module 702 of FIG. 7 is configured to receive a selection of a user review. In one example, the selection of a user review is received via a touchscreen of an electronic device. In another example, the selection of a user review is received via an input device such as a keyboard and/or a mouse of an electronic device. In another example, the selection of a user review is received via a microphone of an electronic device.

As shown by block 1004, the method 1000 also includes determining a location that corresponds to the user review. In one example, the processing module 706 of FIG. 7 is configured to determine a location that corresponds to the user review. In one example, the processing module 706 may be configured to search for words or phrases within the user review that are semantically related to a location. For example, words such as “nearby”, “close”, “around the corner”, and so on, may help do determine the location that corresponds to the user review.

As shown by block 1006, the method 1000 also includes analyzing traffic data, route data, or weather data, or a combination thereof, that corresponds to the location. In one example, the processing module 706 of FIG. 7 is configured to analyze traffic data, route data, or weather data, or a combination thereof, that corresponds to the location. In one example, the traffic data, route data, or weather data, or a combination thereof, is real-time data. In another example, the traffic data, route data, or weather data, or a combination thereof, is historical data associated with a temporal element of the user review.

As shown by block 1008, the method 1000 also includes based on the analysis, providing for display a visual effect associated with the user review. In one example, the input/output module 702 of FIG. 7 is configured to provide an instruction for displaying, via a display screen, a visual effect associated with the user review, based on the analysis. In one example, the visual effect may be a graphic that represents an aspect of the analysis of traffic data, route data, or weather data, or a combination thereof. In another example, the visual effect may be applying a strikethrough effect on certain portions of the user review and augmenting the user review with additional information.

In one embodiment, the method 1000 may further include determining a second location corresponding to the user review. Continuing with this embodiment, the method 1000 may further include analyzing additional traffic data, route data, or weather data, or a combination thereof, that corresponds to the location and the second location.

In one embodiment, the method 1000 may further include determining a score of the user review based on the analysis of the at least one of traffic data, route data, or weather data, or a combination thereof. Continuing with this embodiment, the method 1000 may further include modifying the user review based on the determined score. The score may be determined in any manner as described herein.

In one embodiment, the method 1000 may further include determining a contextual element based on the user review. Continuing with this embodiment, the method 100 may further include analyzing the traffic data, route data, or weather data, or a combination thereof, based on the location and the contextual element.

The processes described herein for generating location-based information may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

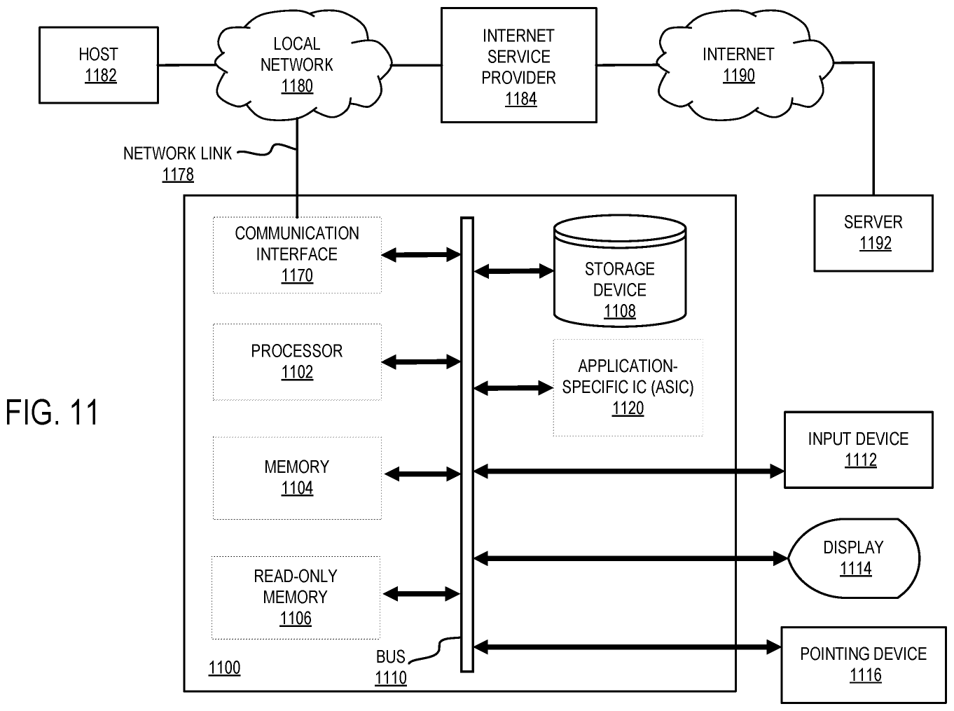

FIG. 11 illustrates a computer system 1100 upon which an embodiment may be implemented. Computer system 1100 is programmed (e.g., via computer program code or instructions) to provide location-based information as described herein and includes a communication mechanism such as a bus 1110 for passing information between other internal and external components of the computer system 1100. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena cart represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1110 includes one or more parallel conductors of information so that information is transferred quickly among devices coupled to the bus 1110. One or more processors 1102 for processing information are coupled with the bus 1110.

A processor 1102 performs a set of operations on information as specified by computer program code related to providing a location-based information. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1110 and placing information on the bus 1110. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1102, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1100 also includes a memory 1104 coupled to bus 1110. The memory 1104, such as a random access memory (RAM) or other dynamic storage device, stores information including processor instructions for providing location-based information. Dynamic memory allows information stored therein to be changed by the computer system 1100. RAM allows a unit of information stored at a location called a memory address to be stored and retrieved independently of information at neighboring addresses. The memory 1104 is also used by the processor 1102 to store temporary values during execution of processor instructions. The computer system 1100 also includes a read only memory (ROM) 1106 or other static storage device coupled to the bus 11110 for storing static information, including instructions, that is not changed by the computer system 1100. Some memory is composed of volatile storage that loses the information stored thereon when power is lost. Also coupled to bus 1110 is a non-volatile (persistent) storage device 1108, such as a magnetic disk, optical disk or flash card, for storing information, including instructions, that persists even when the computer system 1100 is turned off or otherwise loses power.

Information, including instructions for providing location-based information, is provided to the bus 1110 for use by the processor from an external input device 1112, such as a keyboard containing alphanumeric keys operated by a human user, or a sensor. A sensor detects conditions in its vicinity and transforms those detections into physical expression compatible with the measurable phenomenon used to represent information in computer system 1100. Other external devices coupled to bus 1110, used primarily for interacting with humans, include a display 1114, such as a cathode ray tube (CRT) or a liquid crystal display (LCD), or plasma screen or printer for presenting text or images, and a pointing device 1116, such as a mouse or a trackball or cursor direction keys, or motion sensor, for controlling a position of a small cursor image presented on the display 1114 and issuing commands associated with graphical elements presented on the display 1114. In some embodiments, for example, in embodiments in which the computer system 1100 performs all functions automatically without human input, one or more of external input device 1112, display device 1114 and pointing device 1116 is omitted.

In the illustrated embodiment, special purpose hardware, such as an application specific integrated circuit (ASIC) 1120, is coupled to bus 1110. The special purpose hardware is configured to perform operations not performed by processor 1102 quickly enough for special purposes. Examples of application specific ICs include graphics accelerator cards for generating images for display 1114, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

The computer system 1100 may also include one or more instances of a communications interface 1170 coupled to bus 1110. The communication interface 1170 may provide a one-way or two-way communication coupling to a variety of external devices that operate with their own processors, such as printers, scanners and external disks. In addition, the communication interface 1170 may provide a coupling to a local network 1180, by way of a network link 1178. The local network 1180 may provide access to a variety of external devices and systems, each having their own processors and other hardware. For example, the local network 1180 may provide access to a host 1182, or an internet service provider 1184, or both, as shown in FIG. 11. The internet service provider 1184 may then provide access to the Internet 1190, in communication with various other servers 1192.

Computer system 1100 also includes one or more instances of a communication interface 1170 coupled to bus 1110. Communication interface 1170 provides a one-way or two-way communication coupling to a variety of external devices that operate with their own processors, such as printers, scanners and external disks. In general the coupling is with a network link 1178 that is connected to a local network 1180 to which a variety of external devices with their own processors are connected. For example, communication interface 1170 may be a parallel port or a serial port or a universal serial bus (USB) port on a personal computer. In some embodiments, the communication interface 1170 is an integrated services digital network (ISDN) card or a digital subscriber line (DSL) card or a telephone modem that provides an information communication connection to a corresponding type of telephone line. In some embodiments, a communication interface 1170 is a cable modem that converts signals on bus 1110 into signals for a communication connection over a coaxial cable or into optical signals for a communication connection over a fiber optic cable. As another example, the communication interface 1170 may be a local area network (LAN) card to provide a data communication connection to a compatible LAN, such as Ethernet. Wireless links may also be implemented. For wireless links, the communication interface 1170 sends or receives or both sends and receives electrical, acoustic or electromagnetic signals, including infrared and optical signals, that carry information streams, such as digital data. For example, in wireless handheld devices, such as mobile telephones like cell phones, the communication interface 1170 includes a radio band electromagnetic transmitter and receiver called a radio transceiver. In certain embodiments, the communication interface 1170 enables connection to the communication network 115 of FIG. 1 for providing location-based information.

The term computer-readable medium is used herein to refer to any medium that participates in providing information to processor 1102, including instructions for execution. Such a medium may take many forms, including, but not limited to, non-volatile media, volatile media and transmission media. Non-volatile media include, for example, optical or magnetic disks, such as storage device 1108. Volatile media include, for example, dynamic memory 1104. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

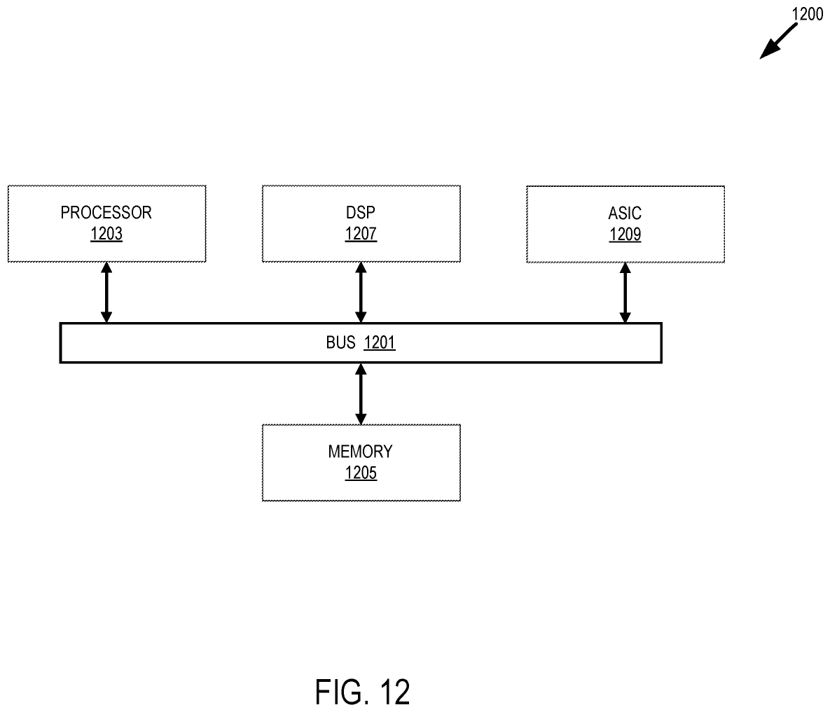

FIG. 12 illustrates a chip set 1200 upon which an embodiment may be implemented. Chip set 1200 is programmed to provide location-based information as described herein and includes, for instance, the processor and memory components described with respect to FIG. 11 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1200 includes a communication mechanism such as a bus 1201 for passing information among the components of the chip set 1200. A processor 1203 has connectivity to the bus 1201 to execute instructions and process information stored in, for example, a memory 1205. The processor 1203 may include one or more processing cores with each core configured to perform independently. A multi-core processor enables multiprocessing within a single physical package. Examples of a multi-core processor include two, four, eight, or greater numbers of processing cores. Alternatively or in addition, the processor 1203 may include one or more microprocessors configured in tandem via the bus 1201 to enable independent execution of instructions, pipelining, and multithreading. The processor 1203 may also be accompanied with one or more specialized components to perform certain processing functions and tasks such as one or more digital signal processors (DSP) 1207, or one or more application-specific integrated circuits (ASIC) 1209. A DSP 1207 typically is configured to process real-world signals (e.g., sound) in real time independently of the processor 1203. Similarly, an ASIC 1209 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1203 and accompanying components have connectivity to the memory 1205 via the bus 1201. The memory 1205 includes both dynamic memory (e.g., RAM, magnetic disk, writable optical disk, etc.) and static memory (e.g., ROM, CD-ROM, etc.) for storing executable instructions that when executed perform the steps described herein to provide location-based information. The memory 1205 also stores the data associated with or generated by the execution of the inventive steps.

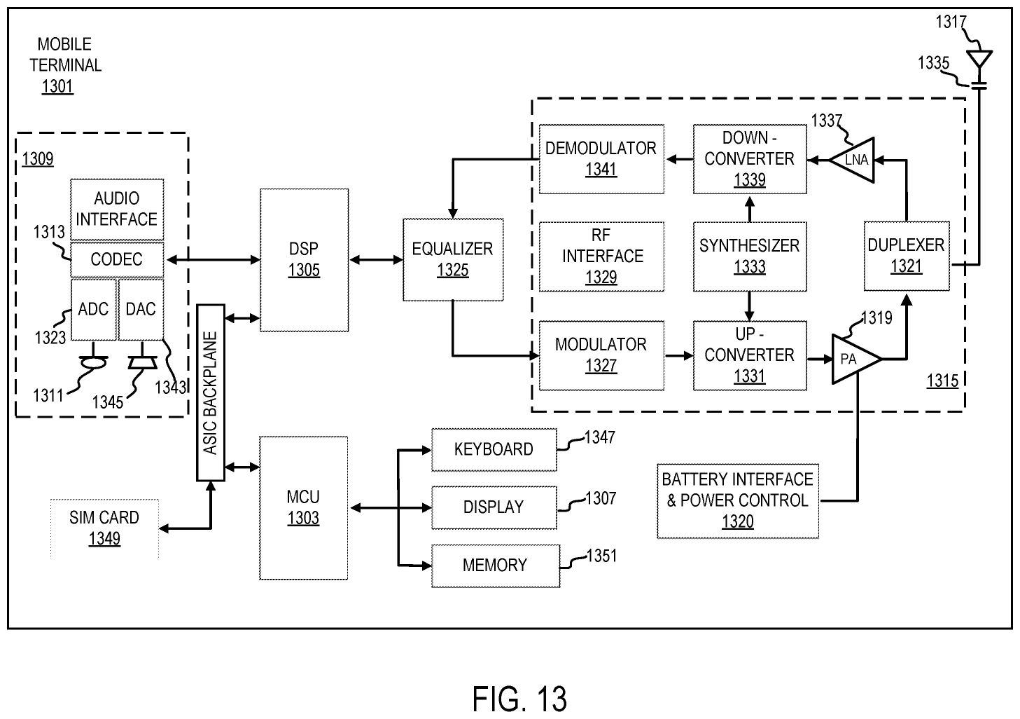

FIG. 13 is a diagram of exemplary components of a mobile terminal 1301 (e.g., a mobile device, vehicle, and/or part thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1303, a Digital Signal Processor (DSP) 1305, and a receiver/transmitter unit including a microphone gain control unit and a speaker gain control unit. A main display unit 1307 provides a display to the user in support of various applications and mobile station functions that offer automatic contact matching. An audio function circuitry 1309 includes a microphone 1311 and microphone amplifier that amplifies the speech signal output from the microphone 1311. The amplified speech signal output from the microphone 1311 is fed to a coder/decoder (CODEC) 1313.

A radio section 1315 amplifies power and converts frequency in order to communicate with a base station, which is included in a mobile communication system, via antenna 1317. The power amplifier (PA) 1319 and the transmitter/modulation circuitry are operationally responsive to the MCU 1303, with an output from the PA 1319 coupled to the duplexer 1321 or circulator or antenna switch, as known in the art. The PA 1319 also couples to a battery interface and power control unit 1320.

In use, a user of mobile terminal 1301 speaks into the microphone 1311 and his or her voice along with any detected background noise is converted into an analog voltage. The analog voltage is then converted into a digital signal through the Analog to Digital Converter (ADC) 1323. The control unit 1303 routes the digital signal into the DSP 1305 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G networks, code division multiple access (CDMA), wireless fidelity (WiFi), satellite, and the like.

The encoded signals are then routed to an equalizer 1325 for compensation of any frequency-dependent impairments that occur during transmission though the air such as phase and amplitude distortion. After equalizing the bit stream, the modulator 1327 combines the signal with a RF signal generated in the RF interface 1329. The modulator 1327 generates a sine wave by way of frequency or phase modulation. In order to prepare the signal for transmission, an up-converter 1331 combines the sine wave output from the modulator 1327 with another sine wave generated by a synthesizer 1333 to achieve the desired frequency of transmission. The signal is then sent through a PA 1319 to increase the signal to an appropriate power level. In practical systems, the PA 1319 acts as a variable gain amplifier whose gain is controlled by the DSP 1305 from information received from a network base station. The signal is then filtered within the duplexer 1321 and optionally sent to an antenna coupler 1335 to match impedances to provide maximum power transfer. Finally, the signal is transmitted via antenna 1317 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1301 are received via antenna 1317 and immediately amplified by a low noise amplifier (LNA) 1337. A down-converter 1339 lowers the carrier frequency while the demodulator 1341 strips away the RF leaving only a digital bit stream. The signal then goes through the equalizer 1325 and is processed by the DSP 1305. A Digital to Analog Converter (DAC) 1343 converts the signal and the resulting output is transmitted to the user through the speaker 1345, all under control of a Main Control Unit (MCU 11303—which can be implemented as a Central Processing Unit (CPU) (not shown).

The MCU 1303 receives various signals including input signals from the keyboard 1347. The keyboard 1347 and/or the MCU 1303 in combination with other user input components (e.g., the microphone 1311) comprise a user interface circuitry for managing user input. The MCU 1303 runs a user interface software to facilitate user control of at least some functions of the mobile station 1301 to provide location-based information. The MCU 1303 also delivers a display command and a switch command to the display 1307 and to the speech output switching controller, respectively. Further, the MCU 1303 exchanges information with the DSP 1305 and can access an optionally incorporated SIM card 1349 and a memory 1351. In addition, the MCU 1303 executes various control functions required of the station. The DSP 1305 may, depending upon the implementation, perform any of a variety of conventional digital processing functions on the voice signals. Additionally, DSP 1305 determines the background noise level of the local environment from the signals detected by microphone 1311 and sets the gain of microphone 1311 to a level selected to compensate for the natural tendency of the user of the mobile terminal 1301.

The CODEC 1313 includes the ADC 1323 and DAC 1343. The memory 1351 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1351 may be, but not limited to, a single memory, CD, DVD, ROM, RAM, EEPROM, optical storage, or any other non-volatile or non-transitory storage medium capable of storing digital data.

An optionally incorporated SIM card 1349 carries, for instance, important information, such as the cellular phone number, the carrier supplying service, subscription details, and security information. The SIM card 1349 serves primarily to identify the mobile terminal 1301 on a radio network. The card 1349 also contains a memory for storing a personal telephone number registry, text messages, and user specific mobile station settings.

While features have been described in connection with a number of embodiments and implementations, various obvious modifications and equivalent arrangements, which fall within the purview of the appended claims are envisioned. Although features are expressed in certain combinations among the claims, it is contemplated that these features can be arranged in any combination and order.

We(I) claim:

1. An apparatus for generating location-based information, the apparatus comprising:
a processor; and
a memory comprising computer program code for one or more programs, wherein the memory and the computer program code is configured to cause the processor of the apparatus to:
determine review information based on a user review;
determine a location associated with the review information;
analyze traffic data based on the location; and
based on the analysis, provide data for modifying the user review.

2. The apparatus of claim 1, wherein the computer code is configured to further cause the processor of the apparatus to:
determine a second location corresponding to the review information; and
analyze additional traffic data based on the location and the second location.

3. The apparatus of claim 1, wherein the computer code is configured to further cause the processor of the apparatus to:
determine a score of the review information based on the analysis of the traffic data.

4. The apparatus of claim 3, wherein the computer code is configured to further cause the processor of the apparatus to:
modify the user review based on the determined score.

5. The apparatus of claim 1, wherein the traffic data is historical traffic data corresponding to a temporal element of the review information.

6. The apparatus of claim 1, wherein the traffic data is real-time traffic data.

7. The apparatus of claim 1, wherein the computer code is configured to further cause the processor of the apparatus to:
determine a contextual element based on the review information; and
analyze the traffic data based on the location and the contextual element.

8. A method for generating location-based information, the method comprising:
determining review information based on a user review;
determining a location corresponding to the review information;
analyzing route data based on the location; and
based on the analysis, providing data for modifying the user review.

9. The method of claim 8, further comprising:
determining a second location corresponding to the review information;
determining one or more routes between the location and the second location based on the analysis of the route data; and
providing information for the one or more routes.

10. The method of claim 8, further comprising:
determining a score of the review information based on the analysis of the route data.

11. The method of claim 10, further comprising:
providing data for modifying the user review based on the determined score.

12. The method of claim 8, wherein the route data is historical route data corresponding to a temporal element of the review information.

13. The method of claim 8, further comprising:
determining a contextual element based on the review information; and
analyzing the route data based on the location and the contextual element.

14. A non-transitory computer-readable storage medium comprising one or more sequences of one or more instructions for execution by one or more processors of a device with a display screen and one or more input devices, the one or more instructions which, when executed by the one or more processors, cause the device to:
determine a location that corresponds to a user review;
analyze traffic data, route data, or weather data, or a combination thereof, that corresponds to the location; and
based on the analysis, provide for display, via the display screen, a visual effect associated with the user review.

15. The non-transitory computer-readable storage medium of claim 14, wherein the one or more instructions which, when executed by the one or more processors, further cause the device to:
determine a second location corresponding to the user review; and
analyze additional traffic data, route data, or weather data, or a combination thereof, that corresponds to the location and the second location.

16. The non-transitory computer-readable storage medium of claim 14, wherein the one or more instructions which, when executed by the one or more processors, further cause the device to:
determine a score of the user review based on the analysis of the at least one of traffic data, route data, or weather data, or a combination thereof.

17. The non-transitory computer-readable storage medium of claim 16, wherein the one or more instructions which, when executed by the one or more processors, further cause the device to:
modify the user review based on the determined score.

18. The non-transitory computer-readable storage medium of claim 14, wherein the at least one of traffic data, route data, or weather data, or a combination thereof, is historical data associated with a temporal element of the user review.

19. The non-transitory computer-readable storage medium of claim 14, wherein the at least one of traffic data, route data, or weather data, or a combination thereof, is real-time data.

20. The non-transitory computer-readable storage medium of claim 14, wherein the one or more instructions which, when executed by the one or more processors, further cause the device to:
determine a contextual element based on the user review; and
analyze the traffic data, route data, or weather data, or a combination thereof, based on the location and the contextual element.
